(19) United States
(12) Patent Application Publication
(10) Pub. No.: US 2003/0083896 A1
(43) Pub. Date: May 1, 2003

(54) Recycle goods sales system and recycle goods sales method

(75) Inventors: Kiyohiko Shinomiya, Tokyo (JP); Takeshi Kamada, Tokyo (JP)

Correspondence Address: RICHARD F. JAWORSKI, Cooper & Dunham LLP, 1185 Avenue of the Americas, New York, NY, 10036, US

(73) Assignee: Richo Company, Ltd.

(21) Appl. No.: 10/251,065

(22) Filed: Sep. 20, 2002

(30) Foreign Application Priority Data
Sep. 21, 2001 (JP) 2001-289252
Jul. 31, 2002 (JP) 2002-223316

(51) Int. Cl. G06F 17/60

(52) U.S. Cl. 705/1; 705/26

(57) ABSTRACT

By adopting a recycle goods sales system, a user can always use a new machine and dispense with a maintenance operation for a consumable member such as a toner on a user's part. A manufacturer can reduce prices of parts of a host machine by employing common parts and earn profits from options such as a printer interface. Therefore, this invention provides the recycle goods sales system which can promote spreading the electronic equipment article which employs the toner as a consumable member.

### BACKGROUND OF THE INVENTION

1) Field of the Invention

The present invention relates to a recycle goods sales system and a recycle goods sales method for an electronic equipment article targeted towards individual users.

2) Description of the Related Art

Generally, the functions of an electronic equipment article targeted towards individual users are relatively limited to less advanced ones since it is necessary to provide the article at low cost. Therefore, ordinary paper copiers and ordinary paper facsimile apparatuses each of which forms images using electrophotographic process have not been widely spread among individual users.

### SUMMARY OF THE INVENTION

It is an object of the present invention to provide a recycle goods sales system and a recycle goods sales method which can promote spreading an electronic equipment article which employs a toner as a consumable member.

According to one aspect of the invention, there is provided a recycle goods sales system comprising, a new article sales cycle in which an electronic equipment article using a toner as a consumable member is produced in a production factory and sold to individual users via a sales company, and a reproduced article sales cycle in which the electronic equipment article used by individual users is recovered and reproduced in a reproduction factory and the reproduced electronic equipment article is sold to the individual user via the sales company, wherein the sales company sells each of the electronic equipment articles to the individual user without differentiating the electronic equipment article sold in the new article sales cycle from the electronic equipment article sold in the reproduced article sales cycle.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIGS. 1A, 1B and 1C are schematic diagrams which explain a recycle goods sales system according to the present invention,

FIG. 2 is a block diagram which shows one example of the configuration of a Group 3 facsimile apparatus applied as an article,

FIG. 3 is a schematic front view which shows one example of an anti-piracy configuration,

FIG. 4 is a schematically partial sectional view which shows one example of the anti-piracy configuration, and

FIG. 5 is a block diagram which explains a constitution for a center machine to acquire information from the Group 3 facsimile apparatus.

### DETAILED DESCRIPTION

An embodiment of a recycle goods sales system according to the present invention will be explained hereinafter in detail with reference to the accompanying drawings.

The recycle goods sales system according to the present invention basically consists of a new article sales cycle and a reproduced article sales cycle.

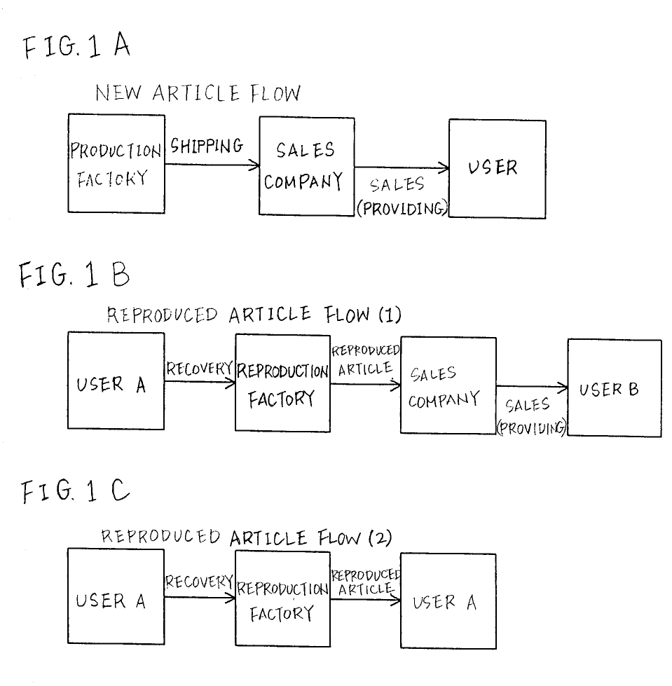

In the new article sales cycle, as shown in FIG. 1A, for example, an article (a new article) produced in a production company is shipped to a sales company, and the sales company sells the article to a user. In the reproduced article sales cycle, as shown in FIG. 1B, for example, an article recovered from a user A is fed to a reproduction factory, in which the article is disassembled and cleaned, and life-expiring parts thereof are exchanged to new parts to thereby have the article finished as a new article and ensure that the quality of the article is equal to that of a new article, and the article is fed to the sales company as the reproduced article, and sold to the user A from a sales company.

As another example of the reproduced article sales system, as shown in FIG. 1C, for example, an article recovered from a user A is fed to a reproduction factory, in which the article is disassembled and cleaned, and life-expiring parts thereof are exchanged to new parts to thereby have the article finished as a new article and ensure that the quality of the article is equal to that of a new article, and the article is returned as a reproduced article to the user A.

The articles targeted herein are assumed to involve electronic equipment such as an ordinary paper copier, an ordinary paper facsimile apparatus and an ordinary paper printer, using a toner as a consumable member.

According to the conventional sales method, the specification of an article is set, for example, such that the life of an article at 100,000 yen is five years. According to this embodiment, by contrast, the specification of an article is set such that the life of an article at 130,000 yen is ten years on the assumption that the article is recycled once for two years. In addition, the number of paper sheets used by a user is set at, for example, “about 1500 for six years”.

In this embodiment, it is premised that an article is recycled. Therefore, such a color as to make discoloration or stains less conspicuous is used in the appearance of a housing. Only the color of a part such as an operation section or an upper cover which tends to be stained is changed while those of the other parts are not changed in finishing the reproduced article as a new article. By doing so, it is possible to make slight color difference, such as the discoloration of a cover which is not to be exchanged, less conspicuous.

A part such as a photosensitive member, a fixing section or an original feed/separation section, which is conventionally exchanged if the life of an article expires (in view of the number of used paper sheets and a using period) during regular maintenance, does not need to be exchanged. Therefore, such a part has a fixed configuration.

As for an example of price setting, a sales price is set at 80,000 yen, a trade-in price is set at 67,000 yen if the using period of the article is less than one year and at 54,000 yen if the using period is not more than one year and less than two years so as to urge a user to subject the article to recycle at an earlier stage.

In reproduction operation performed in the reproduction factory, a plurality of reproduction patterns are prepared to deal with the operation. It is determined which of the reproduction patterns is to be used according to, for example, the number of recycles, a recycle history, months after production, stains, the discoloration of a cover, a damage condition and the like. For example, for a new article, only the toner thereof is filled up. For an old article, not only life-expiring parts but also a cover is exchanged.

Information on the number of recycles, the recycle history, the months after production, the stains, the discoloration of the cover, the damage condition and the like may be held on the article side or on the factory or sales company side.

For each article, the using states (the number of prints and the like) are monitored by a center machine prepared by the sales company. Based on the monitoring content, the sales company executes a sales promotion activity. The center machine automatically provides resale information to both the user and the sales company if the number of used paper sheets reaches 90% within one year after the purchase and 95% within two years after the purchase. The sales company can thereby secure users intended to exchange parts.

On the other hand, in order to enable the quality of an article to be maintained, a toner cartridge exchange mechanism is designed against so-called piracy. For example, a cover is added to a screw which is used when a toner cartridge is detached from a main body, a mechanism which opens and closes this cover is provided, and a specific password or the like is set to be required to actuate the opening/closing mechanism. If a screw the configuration of the head of which is exotic is used as the screw, it is possible to expect a greater result.

By so designing, it is possible to prevent a piracy from illegally supplying the toner of the article and to thereby maintain the quality of the article.

As explained above, by adopting the recycle goods sales system in this embodiment, the user can advantageously, always use a new machine and advantageously dispense with maintenance operation for consumable members such as the toner on the user part. A manufacturer can advantageously reduce the prices of parts of a host machine by employing common parts. In addition, the manufacturer can earn profits from options such as a printer interface (if a main apparatus is a facsimile apparatus) or a facsimile board (if the main apparatus is a printer).

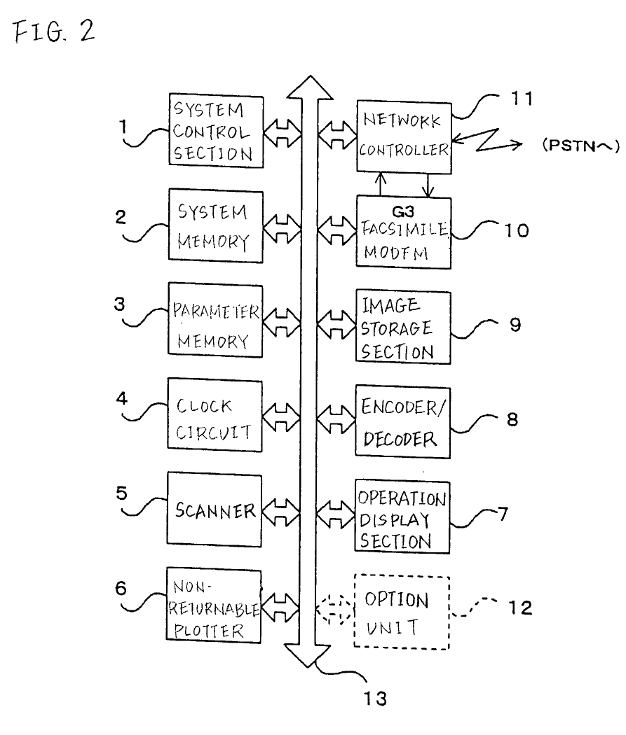

FIG. 2 shows one example of a Group 3 facsimile apparatus which is applied as an article.

In FIG. 2, a system control section 1 performs a control processing for the respective parts of this Group 3 facsimile apparatus and a processing for predetermined Group 3 facsimile transmission control procedures. A system memory 2 stores a control processing program which is executed by the system control section 1 and pieces of various other data required in executing the processing program. The system memory 2 constitutes the work area of the system control section 1. A parameter memory 3 stores pieces of various information particular to this Group 3 facsimile apparatus. A clock circuit 4 outputs present time information.

A scanner 5 reads an original image with a predetermined resolution. A non-returnable plotter 6 records and outputs an image on and to an ordinary paper sheet with a predetermined resolution by electrostatic electrophotographic process. A toner cartridge is fixed to the non-returnable plotter 6. In addition, a photosensitive member, a fixing section and an original feed/separation section in the plotter 6 are set to have fixed configurations, respectively. An operation display section 7 is employed to operate this Group 3 facsimile apparatus and consists of various types of an operation key and various types of a display.

An encoder/decoder 8 encodes and compresses an image signal and decodes image information encoded and compressed to an original image signal. An image storage section 9 stores a number of pieces of information on images which are encoded and compressed.

A Group 3 facsimile modem 10 realizes the modem functions of the Group 3 facsimile apparatus. The Group 3 facsimile modem 10 has a low rate modem function (V.21 modem) to exchange transmission procedure signals and a high rate modem function (V.17 modem, V.34 modem, V.29 modem, V.27ter modem or the like) to mainly exchange image information.

A network controller 11 connects this Group 3 facsimile apparatus to an analog public network PSTN and has an automatic signal transmission/reception function.

An option unit 12 maybe, for example, a printer interface circuit or an additional communication processing unit (e.g., an ISDN connection unit). This option unit 12 enables an additional function to be added to this Group 3 facsimile apparatus.

The system control section 1, the system memory 2, the parameter memory 3, the clock circuit 4, the scanner 5, the plotter 6, the operation display section 7, the encoder/decoder 8, the image storage section 9, the Group 3 facsimile modem 10, the network controller 11 and the option unit 12 are all connected to an internal bus 13. Therefore, these constituent elements exchange data among them mainly via this internal bus 13.

The network controller 11 and the Group 3 facsimile modem 10 directly exchange data with each other without using the internal bus 13.

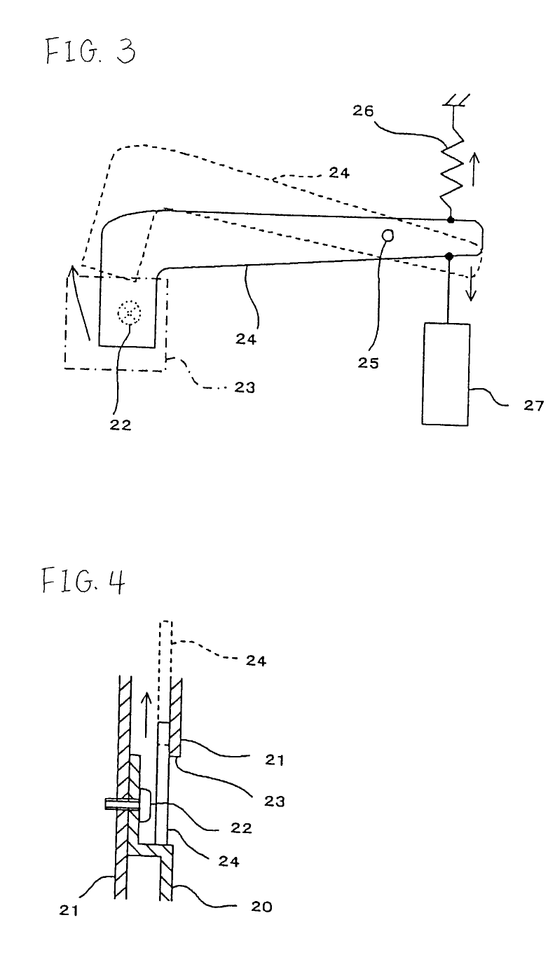

FIGS. 3 and 4 show one example of an anti-piracy configuration.

With this anti-piracy configuration, a screw 22 used when a toner cartridge 20 is detached from a main body 21 is handled via a window 23 provided at the main body 21 and a cover 24 which opens and closes this window 23 are provided.

The cover 24 is formed into generally L-shape and the arm of the cover 24 is rotatably supported by a shaft 25. A spring 26 which causes an urging force for lifting the cover 24 is provided on one end of the cover 24. A solenoid 27 which urges the one end of the cover 24 downward against the urging force of this spring 26.

While the solenoid 27 is turned off, therefore, the urging force of the spring 26 causes the one end of the cover 24 to be urged upward, thus closing the window 23 which is used to operate the screw 22 by the other end of the cover 24. In this state, the screw 22 cannot be rotated so as to detach the toner cartridge 20 from the main body 21.

If the solenoid 27 is turned on, the one end of the cover 24 is urged downward against the urging force of the spring 26, thus detaching the other end of the cover 24 from the window 23 to enable the screw 21 to be operated.

By designating a specific operation mode which is not known to a user from the operation display section 7 and entering a predetermined password in the operation mode, the on/off operation of the solenoid 27 can be operated, thus realizing anti-piracy measures.

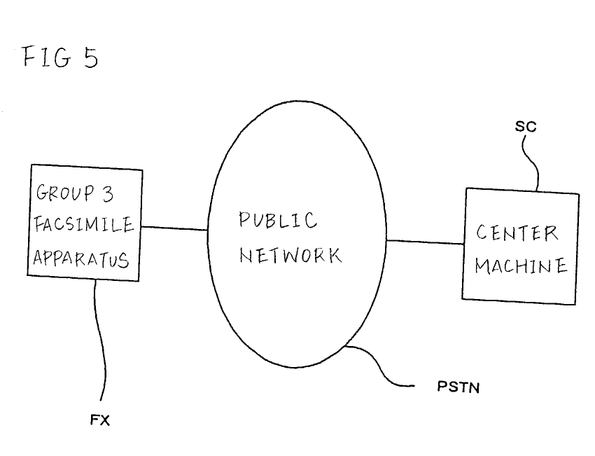

As shown in FIG. 5, this Group 3 facsimile apparatus FX is called by the center machine SC via the public network PSTN and the center machine acquires information on the number of used paper sheets and the like.

In this case, before executing this service, it is necessary to get user's permission. In addition, the time for acquiring the information is set in a time zone in which the acquisition operation does not obstruct the user's use of the facsimile apparatus, e.g., in a midnight zone.

A protocol according to which the center machine SC acquires the information on the Group 3 facsimile apparatus FX, can be arbitrarily selected.

In this embodiment, the example in which the center machine SC is connected to the public network PSTN has been explained. However, even if the center machine SC is connected to the other network such as the Internet, the center machine SC can acquire information on the Group 3 facsimile apparatus FX. In that case, the Group 3 facsimile apparatus FX may include functions which enable the Group 3 facsimile apparatus FX to utilize a network such as the Internet. The Group 3 facsimile apparatus FX may include, for example, a network adapter or the like which connects the Group 3 facsimile apparatus FX to a local area network LAN and an appropriate protocol function so that the Group 3 facsimile apparatus FX can exchange information with the center machine SC.

In this embodiment, the Group 3 facsimile apparatus FX is applied as the electronic equipment which serves as a targeted article. However, the present invention can be similarly applied to the other electronic equipment which employ toner as a consumable member.

As explained so far, according to the embodiment of the present invention, by adopting the recycle goods sales system, the user can advantageously, always use a new machine and can advantageously dispense with a maintenance operation for the consumable part such as a toner on the user's part. In addition, the manufacturer can advantageously reduce the prices of the parts of a host machine by employing common parts and earn profits from options such as a printer interface.

The present document incorporates by reference the entire contents of Japanese priority documents, 2001-289252 filed in Japan on Sep. 21, 2001 and 2002-223316 filed in Japan on Jul. 31, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A recycle goods sales system comprising:
a new article sales cycle in which an electronic equipment article using a toner as a consumable member is produced in a production factory and sold to individual users via a sales company; and
a reproduced article sales cycle in which the electronic equipment article used by individual users is recovered and reproduced in a reproduction factory and the reproduced electronic equipment article is sold to the individual user via the sales company, wherein
the sales company sells each of the electronic equipment articles to the individual user without differentiating the electronic equipment article sold in the new article sales cycle from the electronic equipment article sold in the reproduced article sales cycle.

2. The recycle goods sales system according to claim 1, wherein the individual user who purchases the electronic equipment article in the new article sales cycle is identical with the individual user who purchases the reproduced electronic equipment article.

3. The recycle goods sales system according to claim 1, wherein the individual user who purchases the electronic equipment article in the new article sales cycle is different from the individual user who purchases the reproduced electronic equipment article.

4. The recycle goods sales system according to claim 1, wherein the electronic equipment article is constituted so that the individual user is unable to exchange a development unit using the toner.

5. The recycle goods sales system according to claim 1, wherein the sales company includes a center machine, regularly connects to the electronic equipment article via a communication line using the center machine, and acquires information on the number of prints, and where the sales company conducts a sales promotion activity to the individual user who owns the electronic equipment article in accordance with the number of prints of the electronic equipment article.

6. The recycle goods sales system according to claim 1, wherein the electronic equipment article is designed on assumption that the electronic equipment article is subjected to recycle goods sales.

7. The recycle goods sales system according to claim 1, wherein the electronic equipment article is constituted to release a paper transport path so that a jamming sheet can be removed during paper jamming.

8. A recycle goods sales method comprising:
a new article sales step in which an electronic equipment article using a toner as a consumable member is produced in a production factory and sold to individual users via a sales company; and
a reproduced article sales step in which the electronic equipment article used by individual users is recovered and reproduced in a reproduction factory and the reproduced electronic equipment article is sold to the individual user via the sales company, wherein
the sales company sells each of the electronic equipment articles to the individual user without differentiating the electronic equipment article sold in the new article sales step from the electronic equipment article sold in the reproduced article sales step.

9. The recycle goods sales method according to claim 8, wherein the individual user who purchases the electronic equipment article in the new article sales step is identical with the individual user who purchases the reproduced electronic equipment article.

10. The recycle goods sales method according to claim 8, wherein the individual user who purchases the electronic equipment article in the new article sales step is different from the individual user who purchases the reproduced electronic equipment article.

11. The recycle goods sales method according to claim 8, wherein the electronic equipment article is constituted so that the individual user is unable to exchange a development unit using the toner.

12. The recycle goods sales method according to claim 8, wherein the sales company includes a center machine, regularly connects to the electronic equipment article via a communication line using the center machine, and acquires information on the number of prints, and where the sales company conducts a sales promotion activity to the individual user who owns the electronic equipment article in accordance with the number of prints of the electronic equipment article.

13. The recycle goods sales method according to claim 8, wherein the electronic equipment article is designed on assumption that the electronic equipment article is subjected to recycle goods sales.

14. The recycle goods sales method according to claim 8, wherein the electronic equipment article is constituted to release a paper transport path so that a jamming sheet can be removed during paper jamming.
